(19) United States
(12) Patent Application Publication
(10) Pub. No.: US 2008/0093511 A1
(43) Pub. Date: Apr. 24, 2008

(54) Harness Band

(76) Inventor: Yasuki Wakabayashi, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/667,080

(22) PCT Filed: Oct. 25, 2005
(86) PCT No.: PCT/JP05/19546

§ 371 Date: Aug. 31, 2007

(30) Foreign Application Priority Data
Nov. 5, 2004 (JP) 2004-321519

(51) Int. Cl. F16L 3/137; F16B 2/08

(52) U.S. Cl. 248/74.3

(57) ABSTRACT

A harness band includes: a long band body; a flange body defining a passage hole; and a leg body for being retainingly mounted in a mounting hole in a panel, wherein: the band body had retaining row-like teeth; the flange body includes an elastic tongue piece and having a lock claw and the elastic tongue piece having the lock claw is extended so that it can be inserted into the mounting hole in the panel when the leg body is retainingly mounted in the mounting hole in the panel, and when the elastic tongue piece is bent in a direction to bring the lock claw thereof out of engagement with the retaining row-like teeth of the band body, an outer surface of the elastic tongue piece facing away from the lock claw abuts against an inner peripheral surface of the mounting hole in the panel.

### TECHNICAL FIELD

The present invention relates to a harness band for tying up a harness installed, for example, in the inside of an automobile and for fixing the harness to a predetermined panel.

### BACKGROUND ART

Although not shown specifically, a conventional harness band of this kind is an integrally-molded product of a synthetic resin, and includes a long band body having flexibility, a flange body defining a passage hole for the passage of the band body therethrough, and an elastically-deformable leg body for being retainingly mounted in a mounting hole formed in a panel in such a manner that these bodies are formed integrally with one another, and the construction is such that particularly with respect to the band body, retaining row-like teeth are formed continuously on an outer surface thereof, and with respect to the flange body, an elastic tongue piece depends from a lower part of the passage hole thereof, and lock claws for retaining engagement with the retaining row-like teeth are formed on an inner side of the elastic tongue piece (see, for example, Patent Literature 1).

In actual use, a condition in which a harness is embraced by an inner surface of the long band body is obtained, and a free end portion of the band body is inserted into the passage hole of the flange body, and when the free end portion of the band body is pulled out from the interior of the passage hole of the flange body, the lock claws formed on the inner side of the elastic tongue piece are retainingly engaged with the retaining row-like teeth formed on the outer surface of the band body, so that the harness can be held in a tied-up condition, and therefore thereafter the elastically-deformable leg body is retainingly mounted in the mounting hole in the panel, and by doing so, the harness, while held in the tied-up condition, is fixed to the panel.

Patent Literature 1: Japanese Utility Model Registration No. 2,595,456 Publication

### DISCLOSURE OF THE INVENTION PROBLEM THAT THE INVENTION IS TO SOLVE

Therefore, the conventional harness band has an advantage that it can tie up and fix the harness with the simple operation. However, recently, the mass has been increased by an increased number of harnesses due to an increased number of on-vehicle electronic equipments and also by an increased thickness of the harnesses due to an increased output of the on-vehicle electronic equipments, and on the other hand there is an increasing demand for a compacter design of harness bands, and it has become necessary to firmly hold a harness with a compacter harness band.

### Means for Solving the Problem

The present invention has been developed in order to effectively solve the problem encountered with the above conventional harness band, and the invention recited in claim 1 is directed to a harness band including a long band body having flexibility, a flange body defining a passage hole for the passage of the band body therethrough, and a leg body for being retainingly mounted in a mounting hole in a panel in such a manner that these bodies are formed integrally with one another, wherein the band body has retaining row-like teeth formed continuously on one surface thereof, and the flange body includes an elastic tongue piece depending from a lower part of the passage hole thereof and having a lock claw for retaining engagement with the retaining row-like teeth; characterized in that the elastic tongue piece having the lock claw is extended so that it can be inserted into the mounting hole in the panel when the leg body is retainingly mounted in the mounting hole in the panel, and when the elastic tongue piece is bent in a direction to bring the lock claw thereof out of engagement with the retaining row-like teeth of the band body, an outer surface of the elastic tongue piece facing away from the lock claw abuts against an inner peripheral surface of the mounting hole in the panel.

The invention recited in claim 2, using claim 1 as a premise, is characterized in that in a condition in which the leg body is retainingly mounted in the mounting hole in the panel, the lock claw of the elastic tongue piece is located within a range overlapping a wall thickness of the panel.

The invention recited in claim 3 is directed to a harness band including a long band body having flexibility, a flange body defining a passage hole for the passage of the band body therethrough, and a leg body for being retainingly mounted in a mounting hole in a panel in such a manner that these bodies are formed integrally with one another, wherein the band body has retaining row-like teeth formed continuously on one surface thereof, and the flange body includes an elastic tongue piece depending from a lower part of the passage hole thereof and having lock claws for retaining engagement with the retaining row-like teeth, and the harness band is adapted to be used commonly for panels of different wall thicknesses; characterized in that the elastic tongue piece has the plurality of lock claws formed thereon and arranged along a direction of a length thereof, and when the leg body is retainingly mounted in the mounting hole in the panel, the lock claw of the plurality of lock claws which is close to the flange body is not received in the mounting hole in the panel of a small wall thickness, while the lock claw remote from the flange body is received in the mounting hole in the panel regardless of the wall thickness of the panel.

The invention recited in claim 4 is directed to a harness band including a long band body having flexibility, a flange body defining a passage hole for the passage of the band body therethrough, and a leg body for being retainingly mounted in a mounting hole in a panel in such a manner that these bodies are formed integrally with one another, wherein the band body has retaining row-like teeth formed continuously on one surface thereof, and the flange body includes an elastic tongue piece depending from a lower part of the passage hole thereof and having a lock claw for retaining engagement with the retaining row-like teeth; characterized in that the elastic tongue piece having the lock claw is extended at least to a shoulder portion of the leg body for retaining engagement with a hole edge of the mounting hole in the panel.

The invention recited in claim 5, using claims 1 to 4 as a premise, is directed to a harness band characterized in that a tapering taper portion is formed on an outer surface of a distal end portion of the elastic tongue piece, and also a restraint guide wall which defines a through hole aligned with the passage hole is provided below the tapering taper portion, and a wall thickness of the restraint guide wall is set such that this wall thickness is larger than a wall thickness of a distal end of the tapering taper portion and also is smaller than a wall thickness of the elastic tongue piece.

### Advantages of the Invention

Therefore, in the invention recited in claim 1, the elastic tongue piece having the lock claw is inserted into the interior of the mounting hole in the panel, and is opposed to the inner peripheral surface of the mounting hole in the panel with a narrow gap formed therebetween, and in this connection when the elastic tongue piece is bent in the direction to bring the lock claw thereof out of engagement with the retaining row-like teeth of the band body, the outer surface of the elastic tongue piece facing away from the lock claw abuts against the inner peripheral surface of the mounting hole regardless of the wall thickness of the applied panel, thereby preventing the retaining engagement between the lock claw and the retaining row-like teeth from being canceled, and therefore a harness can always be firmly held.

In the invention recited in claim 2, in the condition in which the leg body is retainingly mounted in the mounting hole in the panel, the lock claw of the elastic tongue piece is located within the range overlapping the wall thickness of the panel, and in this connection even when the elastic tongue piece is bent in the direction to bring the lock claw thereof out of engagement with the retaining row-like teeth of the band body, the lock claw will never be disengaged from the retaining row-like teeth.

In the invention recited in claim 3, during the operation for fastening the band on the harness, that is, in the process in which the retaining row-like teeth of the band body slide in contact with the lock claw while making a snapping sound, the distal end of the lock claw rubs hard against the retaining row-like teeth, and is torn off or worn, or when the band is fastened at high speed by the use of an automatic machine, there is a fear that the lock claw may be melted, and such damaged lock claw can no longer obtain the condition of firm retaining with the retaining row-like teeth. However, in the invention recited in this claim, the plurality of lock claws are formed on the elastic tongue piece, and attention is paid to the lock claw remote from the flange body in which lock claw the above damage will never occur, and the lock claw remote from the flange body is always received in the mounting hole in the panel regardless of the wall thickness of the applied panel, and in this connection after the leg body is retainingly mounted in the mounting hole in the panel, at least the lock claw remote from the flange body can be effectively prevented from being disengaged from the retaining row-like teeth of the band body, and therefore the harness can always be firmly held.

In the invention recited in claim 4, the elastic tongue piece having the lock claw is extended at least to the shoulder portion of the leg body for retaining engagement with the hole edge of the mounting hole in the panel, and in this connection when the elastic tongue piece is bent in the direction to bring the lock claw thereof out of engagement with the retaining row-like teeth of the band body, the outer surface of the elastic tongue piece facing away from the lock claw always abuts against the inner peripheral surface of the mounting hole regardless of the wall thickness of the applied panel, thereby preventing the retaining engagement between the lock claw and the retaining row-like teeth from being canceled, and therefore the harness can always be firmly held.

In the invention recited in claim 5, at the time of inserting the leg body into the mounting hole in the panel, it is merely necessary to insert the restraint guide wall smaller in wall thickness than the elastic tongue piece, and therefore the operation is effected satisfactorily, and once it is inserted into the mounting hole, it is merely necessary to push it thereinto. At this time, the elastic tongue piece will never be caught by the hole edge of the mounting hole in the panel since the wall thickness of the restraint guide wall is larger than a wall thickness of a distal end of the tapering taper portion of the elastic tongue piece.

### BEST MODE FOR CARRYING OUT THE INVENTION

In the present invention, an elastic tongue piece having lock claws is inserted into the interior of a mounting hole in a panel, and is opposed to an inner peripheral surface of the mounting hole in the panel with a narrow gap formed therebetween, and therefore when the elastic tongue piece is bent in a direction to bring the lock claws thereof out of engagement with retaining row-like teeth of a band body, an outer surface of the elastic tongue piece facing away from the lock claws abuts against the inner peripheral surface of the mounting hole regardless of a wall thickness of the panel, thereby preventing the retaining engagement between the lock claws and the retaining row-like teeth from being canceled, so that the condition of positive and firm retaining of the retaining row-like teeth with the lock claws can always be obtained.

### EMBODIMENT

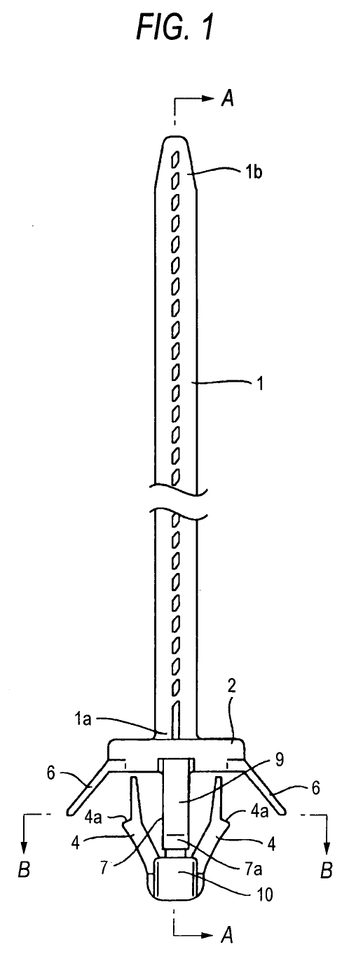

The present invention will hereafter be described in detail on the basis of an illustrated preferred embodiment, and like a conventional one, a harness band of this embodiment is an integrally-molded product of a synthetic resin, and as shown in FIGS. 1 to 4, it includes a long band body 1 having flexibility, a disc-like flange body 2 formed at a proximal end portion 1a of the band body 1 in continuous relation thereto and defining a passage hole 3 for the passage of the band body 1 therethrough, and an elastically-deformable anchor-like leg body 4 depending from a lower surface of the flange body 2 in such a manner that these bodies are formed integrally with one another, and with respect to the band body 1, retaining row-like teeth 5 assuming a saw teeth-like shape are formed continuously on an outer surface thereof in a longitudinal direction, and with respect to the flange body 2, a pair of wing pieces 6 are formed slantingly respectively at opposite edges thereof, and also an elastic tongue piece 7 having lock claws 8 for retaining engagement with the retaining row-like teeth 5 depends from a lower part of the passage hole 3. On this premise, the harness band of this embodiment is characterized in that the following construction is adopted.

Namely, in this embodiment, as shown in the drawings, there is provided the construction in which the elastic tongue piece 7, depending from the lower surface of the flange body 2, is extended so that it can be inserted into a mounting hole in a panel when the above leg body 4 is retainingly mounted in the mounting hole in the panel, and in other words the elastic tongue piece is extended toward the distal end side beyond shoulder portions 4a of the leg body 4 for retaining engagement with a hole edge of the mounting hole in the panel, and the two lock claws 8 are formed on the inner side of the extended elastic tongue piece 7 and are arranged along the direction of the length thereof, and also a tapering taper guide portion 7a is formed on the outer surface of the distal end portion of the elastic tongue piece 7, and a curved surface 9 conforming to a hole diameter of the mounting hole in the panel is positively provided on the outer surface of the elastic tongue piece 7 over the entire length thereof.

In the drawings, 10 denotes a restraint guide wall which is provided beneath the extended elastic tongue piece 7, and defines, together with a central stem portion 4b of the leg body 4 (defining the anchor-shape), a through hole 11 therebetween which is aligned with the above passage hole 3, and this restraint guide wall guides the free end portion 1b of the band body 1, inserted through the passage hole 3, into the through hole 11, and prevents the free end portion 1b of the band body 1 from being opened outwardly, thereby preventing the operation for inserting the leg body 4 into the mounting hole in the panel from becoming difficult, and also it prevents the free end portion 1b of the band body 1 from interfering with a panel surface before the inserting operation or during the inserting operation, thereby eventually preventing the lock claws 8 from being accidentally disengaged from the retaining row-like teeth 5. Furthermore, a curve surface 12 conforming to the hole diameter of the mounting hole in the panel is positively provided on an outer surface of the central stem portion 4b of the leg body 4 (defining the anchor-shape) in a similar manner to the above-mentioned elastic tongue piece 7.

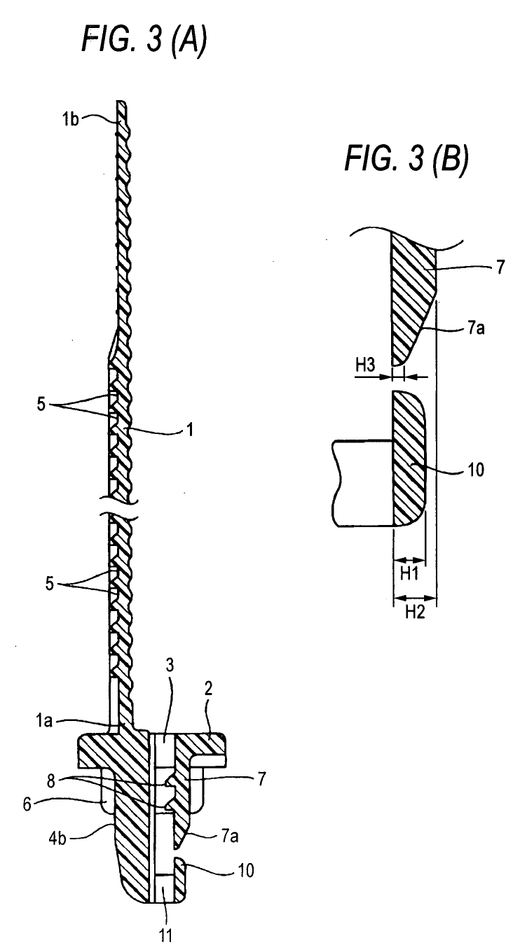

Further, as shown in B of FIG. 3, in this embodiment, when a wall thickness of the above restraint guide wall 10 is represented by H1, a wall thickness of the elastic tongue piece 7 is represented by H2, and a wall thickness of a distal end of the tapering taper guide portion 7a of the elastic tongue piece 7 is represented by H3, the relation, H3<H1<H2, is established.

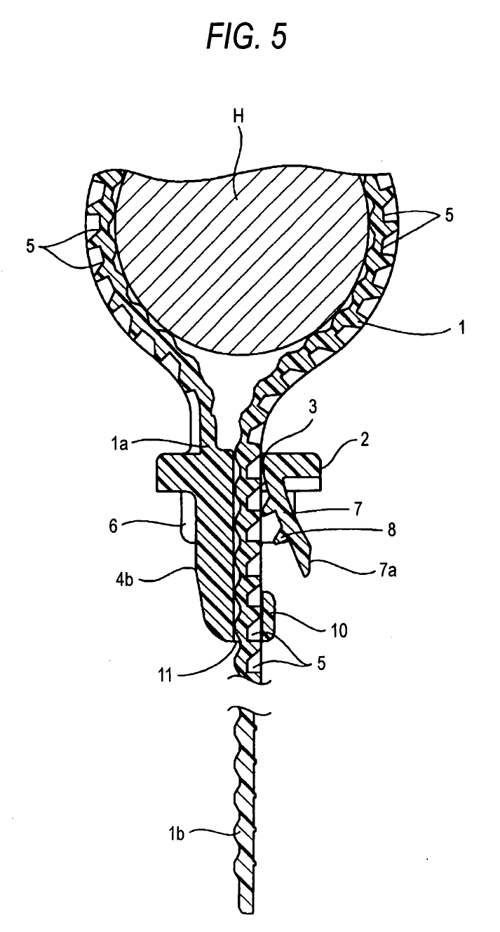

Therefore, when the harness band of this construction is to be used, a condition in which a harness H is embraced by the inner surface of the long band body 1 is obtained, and the free end portion 1b of the band body 1 is inserted into the passage hole 3 of the flange body 2 in a similar manner to the conventional construction, and in this embodiment, when the free end portion 1b of the band body 1 is pulled out to the opposite side through the through hole 11, the elastic tongue piece 7 itself can be flexibly bent outwardly together with the lock claws 8, utilizing its extended long size, as shown in FIG. 5 Therefore, thanks to the flexibility obtained by the length of this elastic tongue piece 7 to be inserted into the mounting hole in the panel, a load and a contact pressure exerted between the lock claws 8 and the retaining row-like teeth 5 are made sufficiently small, and therefore even when the free end portion 1b of the band body 1 is inserted into the passage hole 3 of the flange body 2 at high speed, there is no fear that the lock claws 8 formed on the inner side thereof are shaved to fail to obtain the condition of positive and firm retaining with the retaining row-like teeth 5.

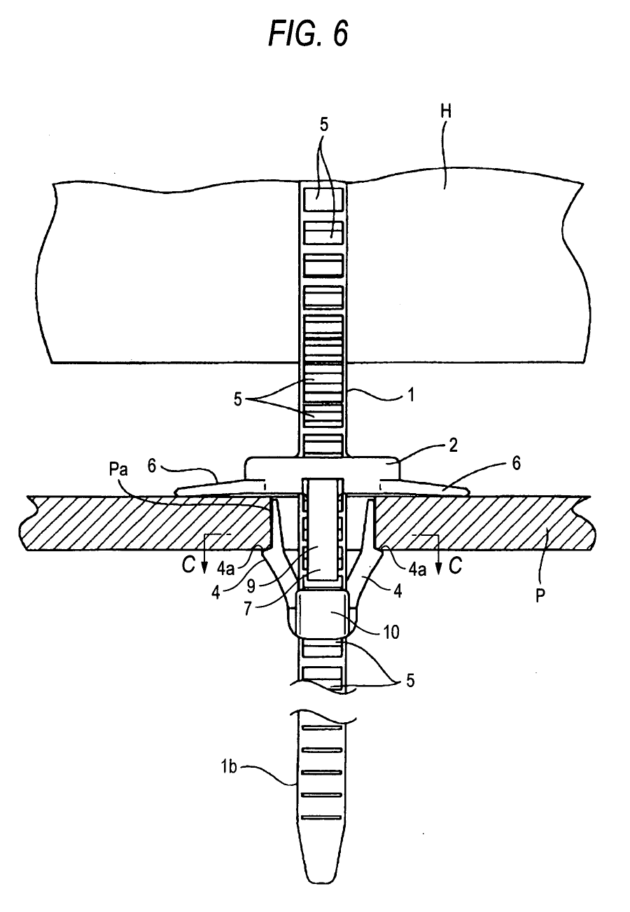

Therefore, as a result, the retaining row-like teeth 5 formed on the outer surface of the band body 1 are retainingly engaged with the lock claws 8 formed on the inner side of the elastic tongue piece 7, so that the harness H is held in a tied-up condition, and therefore thereafter the elastically-deformable leg body 4 is retainingly mounted in the mounting hole Pa in the panel P, and by doing so, the shoulder portions 4a of the anchor-shaped leg body 4 are resiliently retainingly engaged with the hole edge of the mounting hole Pa as shown in FIGS. 6 to 8, and therefore the harness H, while held in the tied-up condition, is fixed to the panel P.

Incidentally, in this case, the elastic tongue piece 7 is also inserted, together with the leg body 4, into the mounting hole Pa in the panel P, but the tapering taper guide portion 7a is formed on the outer surface of the distal end portion of this elastic tongue piece 7, and besides dimensionally, the relation, H3<H1<H2, is established as described above. Therefore, at first, the restraint guide wall 10 smaller in wall thickness than the elastic tongue piece 7 is inserted into the mounting hole Pa, and this inserting operation is effected satisfactorily, and once it is inserted into the mounting hole Pa, it is merely necessary to push it thereinto. At this time, the distal end side of the elastic tongue piece 7 will not be caught by the hole edge of the mounting hole Pa in the panel since the wall thickness of the distal end of the tapering taper guide portion 7a of the elastic tongue piece 7 is the smallest, and therefore the elastic tongue piece 7 is smoothly inserted into the mounting hole Pa in the panel P, and will not be turned up by abutting engagement with the hole edge.

And, at the time when the elastic tongue piece 7 is inserted into the mounting hole Pa, the tapering taper guide portion 7a provided over a long range is guided by the hole edge of the mounting hole Pa, and therefore the back surface of the elastic tongue piece 7 larger in wall thickness than the restraint guide wall 10 is smoothly inserted into the mounting hole Pa, and is opposed to an inner peripheral surface of the mounting hole Pa in close or abutting relation thereto.

And besides, in this fixed condition relative to the panel P, the elastic tongue piece 7 is extended toward the distal end side beyond the shoulder portions 4a of the leg body 4 retainingly engaged with the hole edge of the mounting hole Pa in the panel P as shown in the drawings, and therefore when this elastic tongue piece 7 intends to be bent in a direction to bring the lock claws 8 thereof out of engagement with the retaining row-like teeth 5, the outer surface of the elastic tongue piece 7 provided with the curved surface 9 abuts against the inner peripheral surface of the mounting hole Pa, and receives a strong back-up force from the inner peripheral surface of the mounting hole Pa, and therefore the condition of positive and firm retaining of the retaining row-like teeth 5 of the band body 1 with the lock claws 8 of the elastic tongue piece 7 is obtained, and also the shaking of the harness band itself can be effectively prevented.

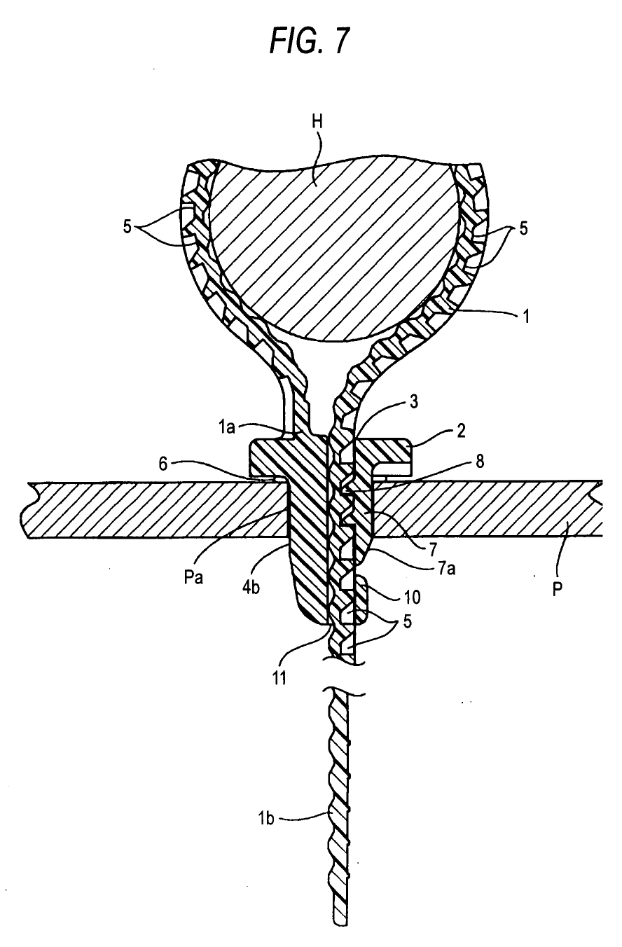

Incidentally, in this case, the object is the panel P having the relatively large wall thickness, and therefore as is clear particularly from FIG. 7, the lock claw 8 close to the flange body 2 and the lock claw 8 remote from the flange body 2 are both received in the mounting hole Pa in the panel P, and are located within a range overlapping the wall thickness of the panel P, and therefore even when the elastic tongue piece 7 is bent in a direction to bring the lock claws 8 thereof out of engagement with the retaining row-like teeth 5 of the band body 1, the lock claws 8 will never be disengaged from the retaining row-like teeth 5.

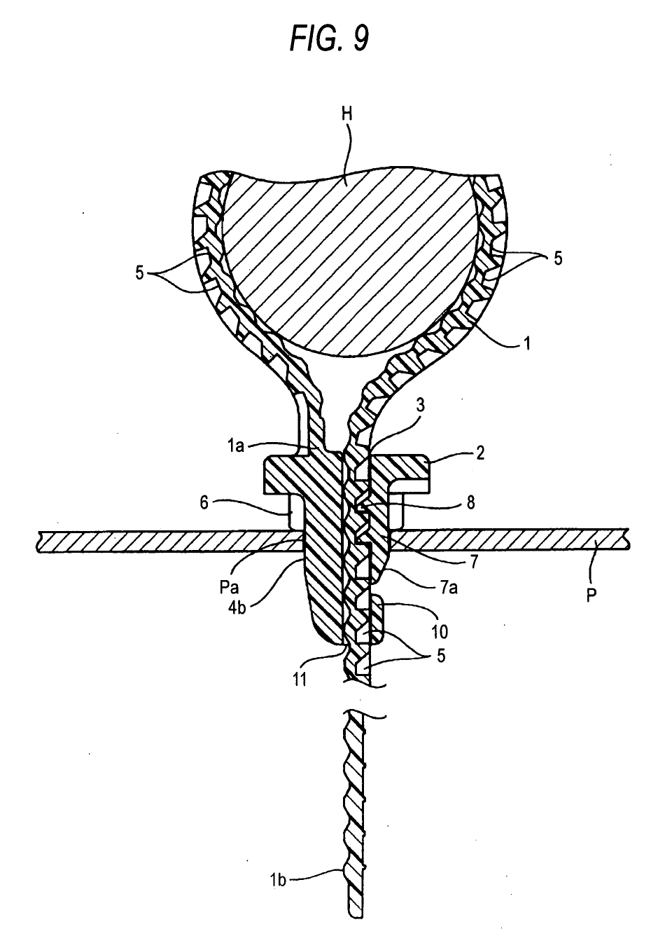

Furthermore, in the case where the object is a panel P having a relative small wall thickness, the distal end of the elastic tongue piece 7 is extended at least to the shoulder portions 4a of the leg body 4 retainingly engaged with a hole edge of a mounting hole Pa in the panel P as shown in FIG. 9, and also in the condition in which the leg body 4 is retainingly mounted in the mounting hole Pa in the panel P, the lock claw 8 remote from the flange body 2 is located within a range overlapping the wall thickness of the panel P, and therefore also when the elastic tongue piece 7 intends to be bent in a direction to bring the lock claws 8 thereof out of engagement with the retaining row-like teeth 5, the outer surface of this elastic tongue piece 7 provided with the curved surface 9 abuts against an inner peripheral surface of the mounting hole Pa and receives a strong back-up force from the inner peripheral surface of the mounting hole Pa.

Therefore, in this embodiment, regardless of the wall thickness of the applied panel P, the outer surface of the elastic tongue piece 7 facing away from the lock claws 8 always abuts against the inner peripheral surface of the mounting hole Pa, and receives the strong back-up force from the inner peripheral surface of the mounting hole Pa, and therefore the condition of positive and firm retaining of the retaining row-like teeth 5 of the band body 1 with the lock claws 8 of the elastic tongue piece 7 is obtained, and also the shaking of the harness band itself can be effectively prevented.

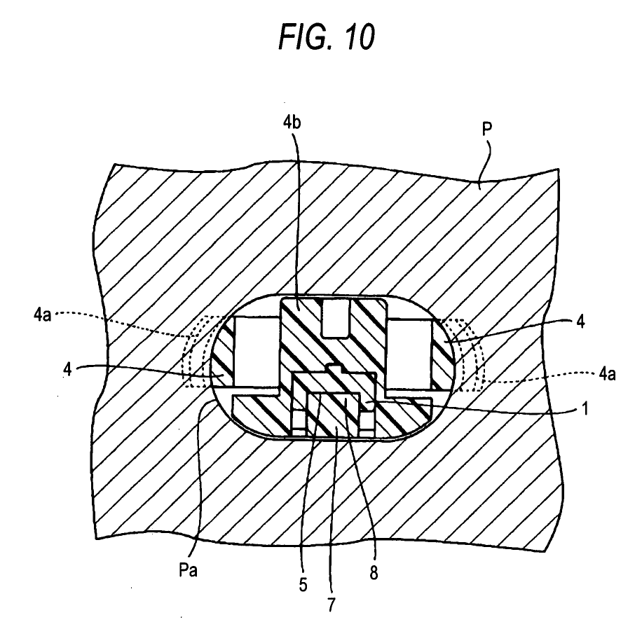

Incidentally, with respect to the above description, although there has been shown the case where the mounting hole Pa formed through the panel P is the round hole, the present invention is not limited to this case, and an embodiment can be applied, for example, to the case where a mounting hole Pa has an oval shape as shown in FIG. 10. Incidentally, in this case, because of the shape of the mounting hole Pa, the curved surface 9 provided on the outer surface of the elastic tongue piece 7 and the curved surface 12 provided on the outer surface of the central stem portion 4b are unnecessary.

### INDUSTRIAL APPLICABILITY

In the harness band of the present invention, the condition of positive and firm retaining of the retaining row-like teeth of the band body with the lock claws of the elastic tongue piece is obtained, and therefore the harness band is quite suitable particularly in the case of tying up the harness installed in the inside of an automobile so as to fix the harness to the panel.

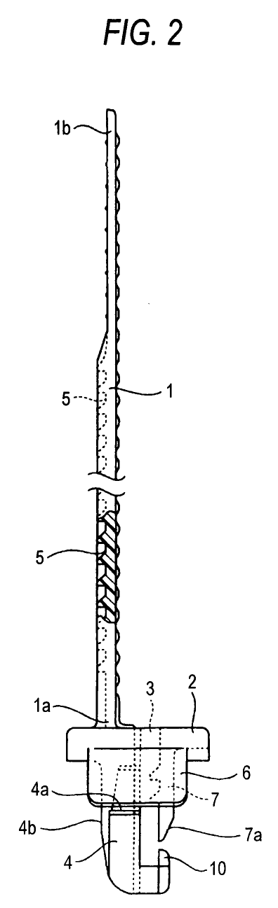

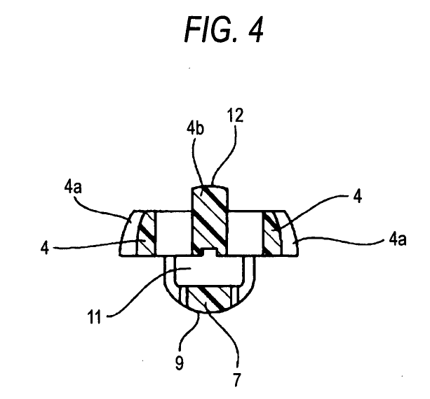

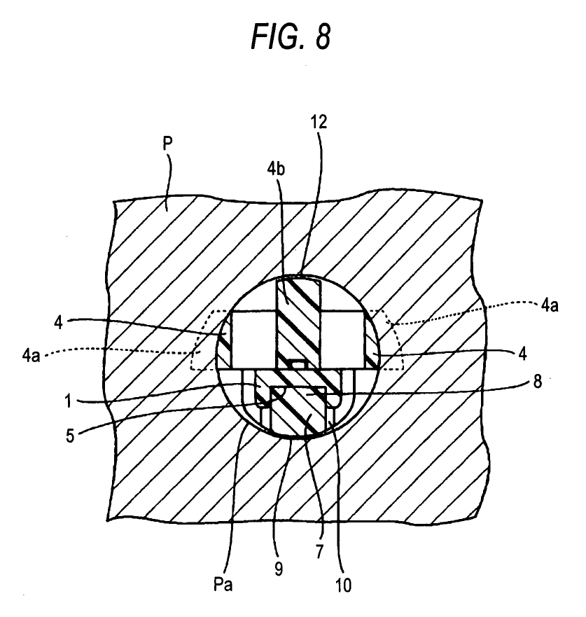

### BRIEF DESCRIPTION OF THE DRAWINGS

[FIG. 1] A front-elevational view showing an embodiment of a harness band of the present invention.

[FIG. 2] A side-elevational view showing the harness band.

[FIG. 3] (A) A cross-sectional view taken along the line A-A of FIG. 1. (B) An enlarged view of an important portion thereof.

[FIG. 4] A cross-sectional view taken along the line B-B of FIG. 1.

[FIG. 5] A cross-sectional view of an important portion showing a condition in which a band body is inserted in a passage hole of a flange body.

[FIG. 6] A cross-sectional view of an important portion showing a condition in which the harness band is fixed to a panel having a large wall thickness.

[FIG. 7] A cross-sectional view of an important portion showing the condition in which the harness band is fixed to the panel having the large wall thickness.

[FIG. 8] A cross-sectional view taken along the line C-C of FIG. 6.

[FIG. 9] A cross-sectional view of an important portion showing a condition in which the harness band is fixed to a panel having a small wall thickness.

[FIG. 10] Across-sectional view of an important portion showing a condition in which an embodiment is applied to the case where a mounting hole in a panel has an oval shape.

### DESCRIPTION OF THE REFERENCE NUMERALS AND SIGNS

1 band body
1a proximal end portion of the band body
1b free end portion of the band body
2 flange body
3 passage hole
4 leg body
4a shoulder portion of the leg body
4b central stem portion of the leg body
5 retaining row-like teeth
6 wing piece
7 elastic tongue piece
7a taper guide portion of the elastic tongue piece
8 lock claw
9 curved surface of the elastic tongue piece
10 restraint guide wall
11 through hole
12 curved surface of the central stem portion
H harness
P panel
Pa mounting hole in the panel

1. A harness band comprising:
a long band body having flexibility;
a flange body defining a passage hole for the passage of the band body therethrough; and
a leg body for being retainingly mounted in a mounting hole in a panel in such a manner that these bodies are formed integrally with one another, wherein:
the band body has retaining row-like teeth formed continuously on one surface thereof;
the flange body includes an elastic tongue piece depending from a lower part of the passage hole thereof and having a lock claw for retaining engagement with the retaining row-like teeth; and
the elastic tongue piece having the lock claw is extended so that it can be inserted into the mounting hole in the panel when the leg body is retainingly mounted in the mounting hole in the panel, in a condition in which the leg body is retainingly mounted in the mounting hole in the panel the lock claw of the elastic tongue piece is located within a range overlapping a wall thickness of the panel, and when the elastic tongue piece is bent in a direction to bring the lock claw thereof out of engagement with the retaining row-like teeth of the band body, an outer surface of the elastic tongue piece facing away from the lock claw abuts against an inner peripheral surface of the mounting hole in the panel.

2. (canceled)

3. A harness band comprising:
a long band body having flexibility;
a flange body defining a passage hole for the passage of the band body therethrough; and
a leg body for being retainingly mounted in a mounting hole in a panel in such a manner that these bodies are formed integrally with one another, wherein:
the band body has retaining row-like teeth formed continuously on one surface thereof;
the flange body includes an elastic tongue piece depending from a lower part of the passage hole thereof and having lock claws for retaining engagement with the retaining row-like teeth, and the harness band is adapted to be used commonly for panels of different wall thicknesses; characterized in that and the elastic tongue piece has the plurality of lock claws formed thereon and arranged along a direction of a length thereof, and when the leg body is retainingly mounted in the mounting hole in the panel, the lock claw of the plurality of lock claws which is close to the flange body is not received in the mounting hole in the panel of a small wall thickness, while the lock claw remote from the flange body is received in the mounting hole in the panel regardless of the wall thickness of the panel.

4. (canceled)

5. A harness band according to claim 1, wherein
a tapering taper portion is formed on an outer surface of a distal end portion of the elastic tongue piece, and also a restraint guide wall which defines a through hole aligned with the passage hole is provided below the tapering taper portion, and a wall thickness of the restraint guide wall is set such that this wall thickness is larger than a wall thickness of a distal end of the tapering taper portion and also is smaller than a wall thickness of the elastic tongue piece.
